(19) United States
(12) Patent Application Publication
(10) Pub. No.: US 2007/0033029 A1
(43) Pub. Date: Feb. 8, 2007

(54) NOISE CANCELLATION HELMET, MOTOR VEHICLE SYSTEM INCLUDING THE NOISE CANCELLATION HELMET, AND METHOD OF CANCELING NOISE IN HELMET

(75) Inventor: Atsushi SAKAWAKI, Iwata-shi, Shizuoka-ken (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/420,067

(22) Filed: May 24, 2006

(30) Foreign Application Priority Data
May 26, 2005 (JP) 2005-154502

(51) Int. Cl. G10L 15/20

(52) U.S. Cl. 704/233

(57) ABSTRACT

A noise cancellation helmet includes a noise detecting unit which detects noise in a helmet body, a sound outputting unit which outputs a control sound for canceling the detected noise, a control signal generating unit which processes an output signal of the noise detecting unit through computation to generate a control signal for the control sound and applies the control signal to the sound outputting unit, an utterance detecting unit which detects utterance of a wearer, an utterance absent period gain adjusting unit which adjusts a gain of the control signal generating unit in an utterance absent period, an utterance absent period gain storing unit which stores a gain set by the utterance absent period gain adjusting unit immediately before the detection of the utterance, and an utterance present period gain adjusting unit which adjusts the gain of the control signal generating unit on the basis of the gain stored in the utterance absent period gain storing unit in an utterance present period.

### BACKGROUND OF THE INVENTION

1. Field of the Invention

The present invention relates to a noise cancellation helmet, a motor vehicle system including the noise cancellation helmet, and a method of canceling noise in the helmet.

2. Description of the Related Art

An active noise cancellation helmet is known and includes microphones and speakers to be located in the vicinity of right and left ears of a helmet wearer for actively canceling noise detected by the microphones by outputting a control sound from the speakers (Japanese Unexamined Patent Publication No. 2000-54219). Thus, noise (mainly wind noise) heard by the helmet wearer is reduced, thereby ensuring a comfortable driving environment.

When the helmet wearer is making a noise, sound or utterance, the wearer's voice or utterance is detected by the noise detection microphones. This prevents proper volume adjustment of the control sound, thereby reducing the effect of the noise cancellation.

### SUMMARY OF THE INVENTION

In order to overcome the problems described above, a preferred embodiment of the present invention provide a noise cancellation helmet that includes a noise detecting unit that is arranged to detect noise in a helmet body, a sound outputting unit that is arranged to output a control sound for canceling the noise detected by the noise detecting unit, a control signal generating unit that is arranged to process an output signal of the noise detecting unit through computation to generate a control signal for the control sound and apply the control signal to the sound outputting unit, an utterance detecting unit that is arranged to detect utterance of a wearer who wears the helmet body, an utterance absent period gain adjusting unit that is arranged to adjust a gain of the control signal generating unit in an utterance absent period during which no utterance is detected by the utterance detecting unit, an utterance absent period gain storing unit that is arranged to store a gain set by the utterance absent period gain adjusting unit immediately before the utterance is detected by the utterance detecting unit, and an utterance present period gain adjusting unit that is arranged to adjust the gain of the control signal generating unit on the basis of the gain stored in the utterance absent period gain storing unit in an utterance present period during which the utterance is detected by the utterance detecting unit.

With this unique arrangement, the control signal is generated according to the noise detected by the noise detecting unit and applied to the sound outputting unit by the control signal generating unit, whereby the control sound is outputted from the sound outputting unit for canceling the noise. Thus, the noise cancellation is performed.

On the other hand, the absence or presence of the utterance of the wearer of the helmet body is detected by the utterance detecting unit. In the utterance absent period during which no utterance is detected, the gain of the control signal generating unit is adjusted by the utterance absent period gain adjusting unit. In the utterance present period during which the utterance is detected, it is impossible to properly cancel the noise by adjusting the gain in the same manner as in the utterance absent period, so that oscillation (howling) may occur. Therefore, the utterance present period gain adjusting unit performs a different gain adjustment control operation during the utterance present period.

More specifically, the gain that is set immediately before the detection of the utterance is stored in the utterance absent period gain storing unit. On the basis of the stored gain, the utterance present period gain adjusting unit adjusts the gain of the control signal generating unit. Therefore, the gain adjustment is achieved without significant influence of the utterance, thereby suppressing or preventing undesired reduction of the noise cancellation effect.

The utterance absent period gain storing unit preferably stores the gain set in the immediately preceding utterance absent period, when the utterance present period gain adjusting unit refers to the stored data. That is, the utterance absent period gain storing unit may include, for example, a stored data updating unit that is arranged to update the data stored in the utterance absent period gain storing unit with a gain constantly set by the utterance absent period gain adjusting unit in the utterance absent period and, in response to the detection of the utterance by the utterance detecting unit, stop the update of the stored data. Thus, the gain that is set in the immediately preceding utterance absent period is stored in the utterance absent period gain storing unit when the utterance is detected.

The noise detecting unit is preferably disposed within the helmet body so as to be located in the vicinity of a wearer's ear when the wearer wears the helmet body. Thus, the noise cancellation is performed based on a sound that is close to a sound actually heard by the wearer. Therefore, the accuracy of the noise cancellation can be improved.

The control signal generating unit is preferably arranged to generate the control signal by inverting a phase of the output signal of the noise detecting unit.

The utterance present period gain adjusting unit is preferably arranged to adjust the gain of the control signal generating unit in accordance with the output signal of the noise detecting unit and the gain stored in the utterance absent period gain storing unit.

The utterance present period gain adjusting unit preferably includes a spectrum computing unit that is arranged to compute a frequency spectrum of the noise in the helmet body on the basis of the output signal of the noise detecting unit, an utterance absent period noise spectrum storing unit that is arranged to store a frequency spectrum computed by the spectrum computing unit immediately before the utterance is detected by the utterance detecting unit, a spectrum comparing unit that is arranged to compare a noise frequency spectrum computed by the spectrum computing unit in the utterance present period during which the utterance is detected by the utterance detecting unit with the frequency spectrum stored in the utterance absent period noise spectrum storing unit, and a gain controlling unit that is arranged to control the gain of the control signal generating unit on the basis of a result of the comparison by the spectrum comparing unit and the gain stored in the utterance absent period gain storing unit.

With this unique arrangement, the noise frequency spectrum computed immediately before the utterance is detected is stored in the utterance absent period noise spectrum storing unit. The noise frequency spectrum computed in the utterance present period is compared with the frequency spectrum computed in the utterance absent period, and the gain of the control signal generating unit is controlled based on the comparison result. Thus, the gain of the control signal generating unit can be controlled according to a change in the noise even in the utterance present period, thereby providing a satisfactory noise cancellation effect.

The frequency spectrum includes an amplitude spectrum and a phase spectrum.

The spectrum comparing unit may be arranged to compare an amplitude spectrum computed in the utterance present period or its equivalent value with an amplitude spectrum computed in the utterance absent period or its equivalent value for at least one specific frequency. The comparison of the amplitude spectra or their equivalent values is preferably made in a frequency range (e.g., in a frequency range of several tens Hz) which is less susceptible to the utterance. More specifically, the comparison is preferably made in a frequency range which is substantially free from a peak attributable to the utterance in the utterance present period amplitude spectrum.

The specific frequency preferably includes a plurality of different frequencies.

The gain controlling unit may be arranged to determine the gain of the control signal generating unit by correcting the gain stored in the utterance absent period gain storing unit on the basis of the result of the comparison by the spectrum comparing unit.

The utterance absent period gain adjusting unit may include a sound pressure ratio acquiring unit that is arranged to acquire a ratio of sound pressures in different frequency ranges on the basis of the output signal of the noise detecting unit, and a gain controlling unit that is arranged to control the gain of the control signal generating unit on the basis of the sound pressure ratio acquired by the sound pressure ratio acquiring unit so as to approximate a spectrum of the output signal of the noise detecting unit to a predetermined target spectrum. The sound pressure as used herein means an index of the loudness of a sound. More specifically, the sound pressure may be an average of amplitudes of sound waves or a root mean square of the amplitudes.

With this unique arrangement, the ratio of the sound pressures in the different frequency ranges is acquired on the basis of the output signal of the noise detecting unit, and the gain of the control signal generating unit is adjusted on the basis of the acquired sound pressure ratio so that the spectrum of the output signal of the noise detecting unit has an optimum profile. This makes it possible to accommodate individual differences in auditory sound conduction function which depends upon the configuration of a space defined between the wearer and the inside wall of the helmet. Thus, a sufficient noise cancellation effect can be provided irrespective of the different characteristics of various helmet wearers.

However, the utterance absent period gain adjusting unit having the above-described construction cannot properly adjust the gain if the frequency spectrum is disturbed by the wearer's voice mixed with wind noise occurring in a wearer's ear space defined between the inside wall of the helmet and the wearer's ear. In various preferred embodiments of the present invention, therefore, the gain of the control signal generating unit is determined in the utterance present period by performing a process different from that in the utterance absent period. This makes it possible to properly perform the noise cancellation control to accommodate the individual differences while minimizing the influence of the utterance.

The sound pressure ratio acquiring unit preferably includes a plurality of filters having different frequency characteristics arranged to filter the output signal of the noise detecting unit, a sound pressure calculating unit that is arranged to process output signals of the respective filters to calculate sound pressures in a plurality of different frequency ranges, and a sound pressure ratio calculating unit that is arranged to calculate the sound pressure ratio as a control index on the basis of the sound pressures calculated for the respective frequency ranges by the sound pressure calculating unit. Thus, the sound pressure ratio as the control index can be acquired with a relatively simple circuit.

Alternatively, the sound pressure ratio acquiring unit may include a first acquisition unit that is arranged to acquire a sound pressure in a resonance frequency range on the basis of the output signal of the noise detecting unit, a second acquisition unit that is arranged to acquire a reference sound pressure as a reference for comparison on the basis of the output signal of the noise detecting unit, and a sound pressure ratio calculating unit that is arranged to calculate a ratio of the sound pressure acquired for the resonance frequency range by the first acquisition unit to the reference sound pressure acquired by the second acquisition unit for the comparison. With this unique arrangement, the sound pressure ratio as the control index can be acquired relatively easily.

The reference sound pressure to be acquired by the second acquisition unit is preferably a sound pressure in a reference frequency range which is less susceptible to the noise cancellation than the resonance frequency range and a noise cancellation frequency range in which the noise is canceled by the sound output from the sound outputting unit. Thus, the sound pressure ratio calculated by the sound pressure ratio calculating unit is dependent upon the sound pressure in the resonance frequency range. Therefore, the level of the sound pressure in the resonance frequency range can be controlled by adjusting the gain of the control signal generating unit, thereby providing a desired spectrum.

The reference frequency range may be a full frequency range. That is, a sound pressure level in the full frequency range may be used as the reference sound pressure. This is because the sound pressure level in the full frequency range is considered to be rarely dependent upon the profile of the spectrum.

The utterance absent period gain adjusting unit is preferably arranged to adjust the gain of the control signal generating unit so that the sound pressure ratio acquired by the sound pressure ratio acquiring unit is approximated to a target sound pressure ratio corresponding to the predetermined target spectrum. Thus, the spectrum of the output signal of the noise detecting unit is approximated to the target spectrum through simple control, thereby providing a satisfactory noise cancellation effect.

The utterance absent period gain adjusting unit preferably sets the gain at zero when no noise is detected. With this unique arrangement, the gain is not needlessly increased, because the gain is set at zero when no noise is present. Therefore, the noise cancellation is not needlessly performed.

The noise cancellation helmet may further include first and second voice detecting units that are arranged to detect the voice of the wearer of the helmet body at different positions within the helmet body and output voice signals. Further, the utterance detecting unit may include a correlation computing unit that is arranged to compute a correlation value indicating a correlation between the voice signals respectively output from the first and second voice detecting units, and an utterance judging unit that is arranged to judge whether or not the wearer is making a noise or utterance on the basis of the correlation value computed by the correlation computing unit.

A noise cancellation helmet according to another preferred embodiment of the present invention includes a noise detecting unit that is arranged to detect noise in a helmet body, a sound outputting unit that is arranged to output a control sound to cancel the noise detected by the noise detecting unit, a control signal generating unit that is arranged to process an output signal of the noise detecting unit through computation to generate a control signal for the control sound and apply the control signal to the sound outputting unit, first and second voice detecting units that are arranged to detect voice of a wearer of the helmet body at different positions within the helmet body and output voice signals, an utterance detecting unit including a correlation computing unit that is arranged to compute a correlation value indicating a correlation between the voice signals respectively output from the first and second voice detecting units and an utterance judging unit that is arranged to judge whether or not the wearer of the helmet body is making an utterance on the basis of the correlation value computed by the correlation computing unit, an utterance absent period gain adjusting unit that is arranged to adjust a gain of the control signal generating unit in an utterance absent period during which no utterance is detected by the utterance detecting unit, and an utterance present period gain adjusting unit that is arranged to adjust the gain of the control signal generating unit through a process that is different from that performed by the utterance absent period gain adjusting unit in an utterance present period during which the utterance is detected by the utterance detecting unit.

With this unique arrangement, whether or not the wearer is making a noise or utterance can be accurately judged on the basis of the correlation value for the output signals of the first and second voice detecting units disposed at the different positions within the helmet body. The gain of the control signal generating unit is adjusted in different manners in the utterance present period and in the utterance absent period, thereby suppressing or preventing undesired reduction of the noise cancellation effect in the utterance present period.

Three or more voice detecting units may be provided, so that whether or not the wearer is making a noise or utterance is judged on the basis of a correlation value for output signals of the three or more voice detecting units.

The first and second voice detecting units are preferably located at positions that are generally equidistant from a mouth of the wearer of the helmet body.

With this unique arrangement, the utterance of the wearer can be more reliably detected. That is, when the voice of the wearer is detected by the first and second voice detecting units respectively located at the positions generally equidistant from the wearer's mouth, there is a significant correlation between the output signals for the voice. On the other hand, the noise is also detected by the first and second voice detecting units, but there is no significant correlation between output signals of the first and second voice detecting units for the noise. Therefore, whether or not the wearer is making a noise or utterance can be detected on the basis of the correlation between the output signals of the first and second voice detecting units.

The first and second voice detecting units are preferably located in the helmet body at positions such that the correlation value computed by the correlation computing unit is not lower than a predetermined threshold in the utterance present period during which the utterance of the wearer of the helmet body is present, and lower than the threshold in the utterance absent period during which the utterance of the wearer of the helmet body is absent.

With this unique arrangement, the detection of the utterance can be more reliably achieved on the basis of the correlation between the output signals of the first and second voice detecting units.

According to a study conducted by the inventor of the present invention, an advantageous result is obtained when the first and second voice detecting units are located in the vicinity of the wearer's mouth rather than in the vicinity of the temples or ears of the wearer in the helmet body. That is, where the first and second voice detecting units are located in the vicinity of the wearer's mouth, there is a significant correlation between the output signals of the first and second voice detecting units for the voice of the wearer (between voice signals in a voice frequency range), but there is no significant correlation between the output signals of the first and second voice detecting units for the noise in any frequency range. Therefore, the voice of the wearer and the noise can be properly separated from each other by locating the first and second voice detecting units in the vicinity of the wearer's mouth within the helmet body. Thus, the presence or absence of the utterance of the wearer can be accurately detected.

All the components of the noise cancellation helmet may be mounted in the helmet body, but this is not necessarily required. For example, the noise detecting unit and the sound outputting unit (and, as required, the voice detecting units which detect the voice of the helmet wearer) may be mounted in the helmet body, and at least some of the other components may constitute a device separate from the helmet body.

A motor vehicle system according to another preferred embodiment of the present invention includes a vehicle body, and the above-described noise cancellation helmet, wherein at least the noise detecting unit and the sound outputting unit (and, as required, the voice detecting units which detect the voice of the helmet wearer) are mounted in the helmet body of the noise cancellation helmet, and at least some of the components of the noise cancellation helmet other than the noise detecting unit and the sound outputting unit (and, as required, the voice detecting units) of the noise cancellation helmet constitute a vehicle-side device provided in the vehicle body. The motor vehicle system further includes a communication unit that is arranged to transmit a signal between the vehicle-side device and the noise detecting unit and between the vehicle-side device and the sound outputting unit (and, as required, between the vehicle-side device and the voice detecting units). With this unique arrangement, some of the components of the noise cancellation helmet are disposed in the vehicle body.

A motor vehicle system according to another preferred embodiment of the present invention includes a vehicle body, the above-described noise cancellation helmet, an audible information generating unit provided in the vehicle body and arranged to generate audible information, a transmission unit that is arranged to transmit the audible information generated by the audible information generating unit to the helmet body of the noise cancellation helmet, and an audible information outputting unit provided in the helmet body and arranged to output the audible information transmitted by the transmission unit.

With this unique arrangement, the audible information from the audible information generating unit mounted in the vehicle body can be provided to the helmet wearer, while the noise in the helmet body is canceled irrespective of the individual differences between various helmet wearers. Thus, the helmet wearer can comfortably hear the provided audible information.

Examples of the audible information generating unit include a navigation system which provides audible guidance information, a mobile phone such as a cellular phone, a radio and an audio system.

Examples of the transmission unit include a wire communication unit that is arranged to connect the audible information generating unit to the helmet body via a cable, and a wireless communication unit for infrared communication or radio communication.

A typical example of the audible information outputting unit is a speaker provided in the helmet body. For example, a single speaker provided in the helmet body may preferably be used as the audible information outputting unit and the sound outputting unit for the noise cancellation. Alternatively, separate speakers respectively defining the audible information outputting unit and the sound outputting unit for the noise cancellation may preferably be provided in the helmet body.

A method of canceling noise in a helmet according to another preferred embodiment of the present invention includes the steps of detecting noise in a helmet body by a noise detecting unit, outputting a control sound from a sound outputting unit for canceling the detected noise, processing an output signal of the noise detecting unit through computation to generate a control signal, amplifying the generated control signal by an amplification unit and applying the amplified control signal to the sound outputting unit, detecting an utterance of a wearer who wears the helmet body, adjusting a gain of the amplification unit in an utterance absent period during which the utterance of the wearer is not detected, and adjusting the gain of the amplification unit on the basis of a gain set in the immediately preceding utterance absent period gain adjusting step in an utterance present period during which the utterance of the wearer is detected.

In this method, the gain of the amplification unit is adjusted in the utterance present period on the basis of the gain set in the immediately preceding utterance absent period, so that the noise in the helmet is properly cancelled without a significant influence of the utterance.

A method of canceling noise in a helmet according to another preferred embodiment of the present invention includes the steps of detecting noise in a helmet body by a noise detecting unit, outputting a control sound from a sound outputting unit for canceling the detected noise, processing an output signal of the noise detecting unit through computation to generate a control signal, amplifying the generated control signal by an amplification unit and applying the amplified control signal to the sound outputting unit, detecting a voice of a wearer of the helmet body at different positions within the helmet body by first and second voice detecting units, computing a correlation value indicating a correlation between voice signals respectively output from the first and second voice detecting units, judging whether or not the wearer of the helmet body is making a noise or utterance on the basis of the calculated correlation value, adjusting a gain of the amplification unit in an utterance absent period during which it is judged that the wearer is not making a noise or utterance, and adjusting the gain of the amplification unit through a process different from that performed in the utterance absent period gain adjusting step in an utterance present period during which it is judged that the wearer is making a noise or utterance.

In this method, the utterance of the helmet wearer can be accurately detected. Since the gain adjustment is performed in different manners in the utterance present period and in the utterance absent period, it is possible to cancel the noise in the helmet while minimizing the influence of the utterance.

The foregoing and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a block diagram illustrating the construction of an active noise cancellation helmet according to one preferred embodiment of the present invention;

FIG. 1B is an exterior view of the active noise cancellation helmet of FIG. 1A;

FIG. 2 is a diagram illustrating the construction of a control system of the active noise cancellation helmet according to the aforementioned preferred embodiment of the present invention;

FIG. 3 is a block diagram illustrating an exemplary construction of an utterance detector;

FIG. 4 is an exemplary graph of coherence computed by a coherence computing section;

FIGS. 5A and 5B are diagrams for explaining the preferred positions of utterance detection microphones in a helmet body;

FIGS. 6A and 6B are exemplary graphs of coherence obtained when the utterance detection microphones are located at the positions shown in FIGS. 5A and 5B;

FIG. 7 is a flow chart for explaining the overall operation of a gain adjusting circuit;

FIG. 8 is a diagram for explaining a specific example of the function of a spectrum comparing circuit;

FIG. 9 is a block diagram illustrating an exemplary construction of the spectrum comparing circuit which includes band pass filters;

FIG. 10 is a diagram illustrating an exemplary gain map for computing a control gain;

FIG. 11 is a block diagram illustrating an exemplary construction of an utterance absent period gain adjusting circuit;

FIG. 12 is a diagram for explaining active noise cancellation control to be performed by the circuit of FIG. 11;

FIGS. 13A, 13B and 13C are diagrams for explaining the effects of the active noise cancellation control to be performed by the utterance absent period gain adjusting circuit, particularly, FIG. 13A illustrates an effect achieved when great wind noise is present, FIG. 13B illustrates an effect achieved when small wind noise is present, and FIG. 13C illustrates an effect achieved when no wind noise is present;

FIG. 14 is a diagram illustrating the overall construction of a motor vehicle system including the an active noise cancellation helmet according to another preferred embodiment of the present invention; and

FIG. 15 is a block diagram illustrating the electrical construction of the motor vehicle system.

### DETAILED DESCRIPTION OF PREFERRED EMBODIMENTS

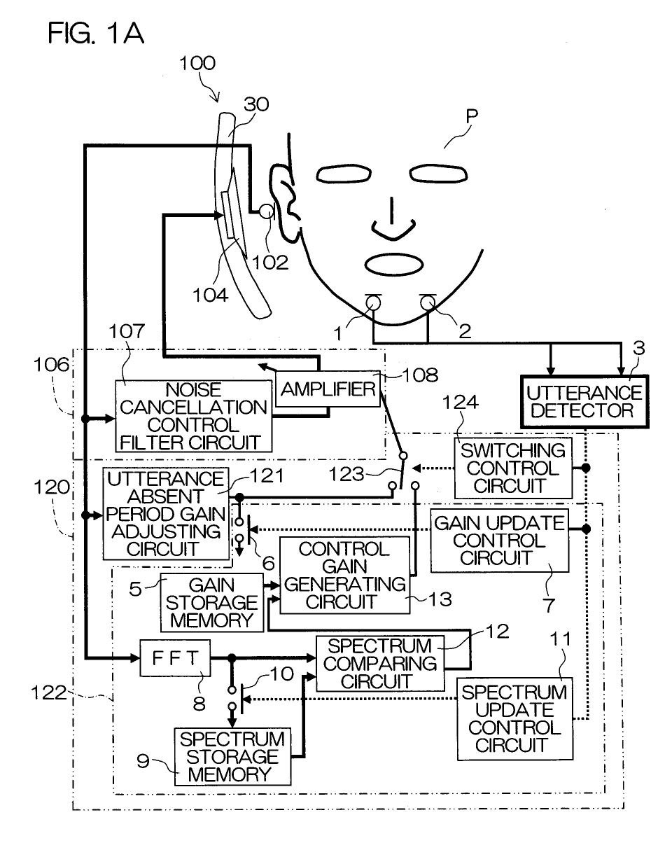

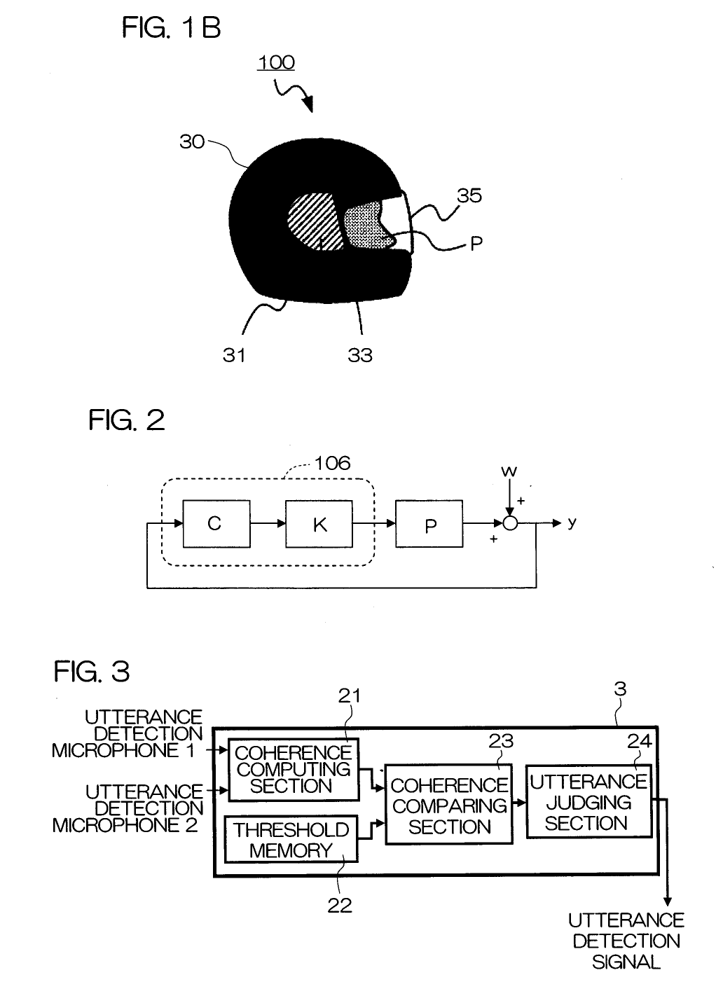

FIG. 1A is a block diagram illustrating the construction of an active noise cancellation helmet according to one preferred embodiment of the present invention, and FIG. 1B is an exterior view of the active noise cancellation helmet of FIG. 1A.

The active noise cancellation helmet 100 is an active noise cancellation device of a feedback type. The active noise cancellation helmet 100 preferably includes a microphone 102 (noise detecting unit) which detects noise (e.g., wind noise or other types of noise) in the helmet, a speaker 104 (sound outputting unit) which outputs a control sound (secondary sound) for actively canceling the detected noise, a control signal generating circuit 106 (control signal generating unit) which processes output signals of the microphone 102 through computation to generate a control signal for outputting the noise cancellation control sound (secondary sound), and a gain adjusting circuit 120 which adjusts the gain (control gain) of the control signal generating circuit 106. The control signal generating circuit 106 includes a noise cancellation control filter circuit 107, and an amplifier 108 (amplification unit) having a gain which is variably set. A control signal output from the amplifier 108 is applied to the speaker 104. The gain adjusting circuit 120 adjusts the gain (control gain) of the amplifier 108.

The microphone 102 and the speaker 104 are disposed at proper predetermined positions within a shell 31 of a helmet body 30. More specifically, as shown in FIG. 1A, the microphone 102 and the speaker 104 are preferably located in an ear space that is adjacent to an ear of a user (helmet wearer) P when the user P wears the helmet body 30. Particularly, the microphone 102 is located in the vicinity of the user's ear between the user's ear and the speaker 104 so as to detect a sound that is close to a sound heard by the user P. The position of the microphone 102 is defined as a noise cancellation point. In FIG. 1B, a reference numeral 33 denotes a cover, and a reference numeral 35 denotes a shield.

The noise cancellation control filter circuit 107 samples an instantaneous value of a sound wave detected by the microphone 102 at the predetermined position (noise cancellation point) in the ear space within the helmet, and computes a control signal for driving the speaker 104 so that a sound pressure level at the noise cancellation point in the ear space is minimized. The control signal is amplified by the amplifier 108 and applied to the speaker 104, and the control sound is output from the speaker 104 in the ear space on the basis of the control signal. Thus, the noise in the ear space adjacent to the user's ear is cancelled. Thus, the control signal generating circuit 106 adaptively controls the output of the speaker 104 so as to minimize the sound at the position of the microphone 102.

FIG. 2 is a diagram illustrating the construction of a control system of the active noise cancellation helmet according to this preferred embodiment. In FIG. 2, a reference character P denotes a frequency conduction function (auditory sound conduction function) to be controlled, a reference character C denotes a frequency conduction function of the noise cancellation control filter circuit 107, and a reference character K denotes a control gain (the gain of the amplifier 108). A reference character y indicates the output of the microphone 102, and a reference character w indicates noise (e.g., wind noise).

The sound heard by the user P is close to the output y of the microphone 102 and, therefore, the active noise cancellation helmet 100 operates to reduce the level of the output y of the microphone 102. In a known automatic control theory, the frequency conduction function C of the noise cancellation control filter circuit 107 is designed in the form of a negative inverse of the auditory sound conduction function P (i.e., C=−P⁻¹), and the microphone output y is approximated to zero (0) by increasing the control gain K. However, it is difficult to design the control filter C in the form of the negative inverse of the auditory sound conduction function P in a full frequency range. If the control gain K is increased, the sound is progressively amplified to excess at a certain frequency (resonance frequency) resulting in divergence (howling). Thus, the noise cancellation and the excessive amplification are inextricably linked with each other. Therefore, the control gain K should be adjusted at a proper level in order to provide a sufficient noise cancellation effect while properly suppressing the amplification.

For example, an experiment reveals that, in a noise cancellation frequency range (noise cancellation range) of 100 Hz to 400 Hz, the active noise cancellation is effective, and the noise cancellation effect is increased as the control gain K is increased. On the other hand, the resonance frequency is about 2.5 kHz, at which the amplification effect is increased as the control gain K is increased. That is, when an attempt is made to reduce a control amount (here, the microphone output y) in a certain frequency range, the control amount is increased in another frequency range. This phenomenon is generally known as the “waterbed effect”.

On the other hand, it is known that the auditory sound conduction function differs among individuals. More specifically, the phase of the auditory sound conduction function as well as the profile of the gain thereof (frequency dependency) do not depend so much on individuals while the gain of the conduction function is entirely shifted depending on the individual users. If the control gain is evenly adjusted without consideration of the individual differences, the control gain K is excessively effective thereby resulting in divergence depending on the users as described above, or, conversely, is ineffective to reduce the noise cancellation effect to a level that is lower than expected even without divergence. Therefore, if the gain to be controlled differs among individuals, it is necessary to adaptively adjust the control gain K.

Referring again to FIGS. 1A and 1B, within the helmet body 30, a pair of utterance detection microphones 1, 2 (first and second voice detecting units) are located at preferred positions that are preferably equidistant from the mouth of the user P in the vicinity of the user's mouth. The active noise cancellation helmet 100 further includes an utterance detector 3 (utterance detecting unit) which receives output signals of the utterance detection microphones 1, 2 to detect an utterance (e.g., sound, noise, speech, etc.) made by the user P.

On the other hand, the gain adjusting circuit 120 includes an utterance absent period gain adjusting circuit 121 (utterance absent period gain adjusting unit) which adjusts the control gain in an utterance absent period during which the user P does not make any sound, in other words, when an utterance of the user P is absent, an utterance present period gain adjusting circuit 122 (utterance present period gain adjusting unit) which adjusts the control gain in an utterance present period during which the user P makes a sound, in other words, an utterance of the user P is present, a gain adjustment switching circuit 123 which selects one of the control gain generated by the utterance absent period gain adjusting circuit 121 and the control gain generated by the utterance present period gain adjusting circuit 122 and inputs the selected control gain to the amplifier 108, and a switching control circuit 124 which controls the gain adjustment switching circuit 123 on the basis of the result of the detection by the utterance detector 3.

In the utterance absent period during which the utterance of the user P is not detected, the switching control circuit 124 controls the gain adjustment switching circuit 123 so that the control gain output from the utterance absent period gain adjusting circuit 121 is applied to the amplifier 108. In the utterance present period during which the utterance of the user P is detected, the switching control circuit 124 controls the gain adjustment switching circuit 123 so that the control gain output from the utterance present period gain adjusting circuit 122 is applied to the amplifier 108.

The utterance present period gain adjusting circuit 122 includes a gain storage memory 5 (utterance absent period gain storing unit) for storing the gain output from the utterance absent period gain adjusting circuit 121, a gain update switch 6 which permits or prohibits update of the control gain stored in the gain storage memory 5 with the control gain output from the utterance absent period gain adjusting circuit 121, and a gain update control circuit 7 which controls the gain update switch 6 on the basis of the result of the detection by the utterance detector 3. Thus, the gain update switch 6 and the gain update control circuit 7 constitute a stored data updating unit for updating the data stored in the gain storage memory 5.

The utterance present period gain adjusting circuit 122 preferably also includes a Fast Fourier Transform (FFT) circuit 8 (spectrum computing unit) which generates the frequency spectrum of the output signal of the microphone 102, a spectrum storage memory 9 (utterance absent period noise spectrum storing unit) for storing the frequency spectrum output from the Fast Fourier Transform circuit 8, a spectrum update switch 10 which permits or prohibits update of the data stored in the spectrum storage memory 9 with the frequency spectrum output from the Fast Fourier Transform circuit 8, and a spectrum update control circuit 11 which controls the spectrum update switch 10 on the basis of the result of the detection by the utterance detector 3. The frequency spectrum includes an amplitude spectrum and a phase spectrum.

The utterance present period gain adjusting circuit 122 further includes a spectrum comparing circuit 12 (spectrum comparing unit) which compares the frequency spectrum computed by the Fast Fourier Transform circuit 8 with the frequency spectrum stored in the spectrum storage memory 9 and computes a comparison value on the basis of the result of the comparison, and a control gain generating circuit 13 (gain controlling unit) which generates the control gain to be applied to the amplifier 108 in the utterance present period on the basis of the comparison value generated by the spectrum comparing circuit 12 and the control gain stored in the gain storage memory 5. The control gain generated by the control gain generating circuit 13 is input to the gain adjustment switching circuit 123.

In the utterance absent period, the gain update control circuit 7 controls the gain update switch 6 in an update permitted state. Thus, the control gain generated by the utterance absent period gain adjusting circuit 121 is applied to the gain storage memory 5 to constantly update the control gain stored in the gain storage memory 5. On the other hand, upon detection of the utterance of the user P by the utterance detector 3, the gain update control circuit 7 switches the gain update switch 6 into an update prohibited state. Thus, a control gain output from the utterance absent period gain adjusting circuit 121 immediately before the detection of the utterance is retained in the gain storage memory 5.

On the other hand, in the utterance absent period during which no utterance is detected by the utterance detector 3, the spectrum update control circuit 11 controls the spectrum update switch 10 in an update permitted state. Thus, the frequency spectrum generated by the Fast Fourier Transform circuit 8 is applied to the spectrum storage memory 9 to constantly update the data stored in the spectrum storage memory 9. In contrast, in the utterance present period during which the utterance of the user P is detected by the utterance detector 3, the spectrum update control circuit 11 controls the spectrum update switch 10 in an update prohibited state to prohibit the update of the date stored in the spectrum storage memory 9. As a result, a frequency spectrum observed in an utterance absent period immediately preceding the detection of the utterance is stored in the spectrum storage memory 9.

Therefore, in the utterance present period, the spectrum comparing circuit 12 compares the frequency spectrum observed in the utterance present period with the frequency spectrum observed in the immediately preceding utterance absent period and generates the comparison value on the basis of the result of the comparison. Then, the control gain generating circuit 13 generates the control gain on the basis of the comparison value and the control gain stored in the gain storage memory 5 in the immediately preceding utterance absent period. As a result, the control gain (stored in the gain storage memory 5) generated in the utterance absent period immediately preceding the detection of the utterance of the user P is corrected on the basis of the result of the comparison between the frequency spectrum observed in the immediately preceding utterance absent period and the frequency spectrum indicating the present noise condition in the helmet body 30 for the generation of the control gain. The control gain generating circuit 13 may provide a gain map which outputs the control gain to be applied to the amplifier 108 upon reception of the control gain stored in the gain storage memory 5 and the comparison value generated by the spectrum comparing circuit 12.

Thus, it is possible to perform a gain control operation based on constantly changing noise conditions while minimizing the influence of the utterance of the user P, and to provide highly effective noise cancellation in the utterance present period as well as in the utterance absent period.

FIG. 3 is a block diagram illustrating an exemplary construction of the utterance detector 3. The utterance detector 3 preferably includes a coherence computing section 21 (correlation computing unit) which computes coherence (correlation) of the sound signals respectively output from the utterance detection microphones 1, 2, a threshold memory 22 which stores a threshold for the coherence computed by the coherence computing section 21, a coherence comparing section 23 which compares the coherence computed by the coherence computing section 21 with the threshold stored in the threshold memory 22, and an utterance judging section 24 (utterance judging unit) which judges whether or not the utterance is present on the basis of the result of the comparison by the coherence comparing section 23.

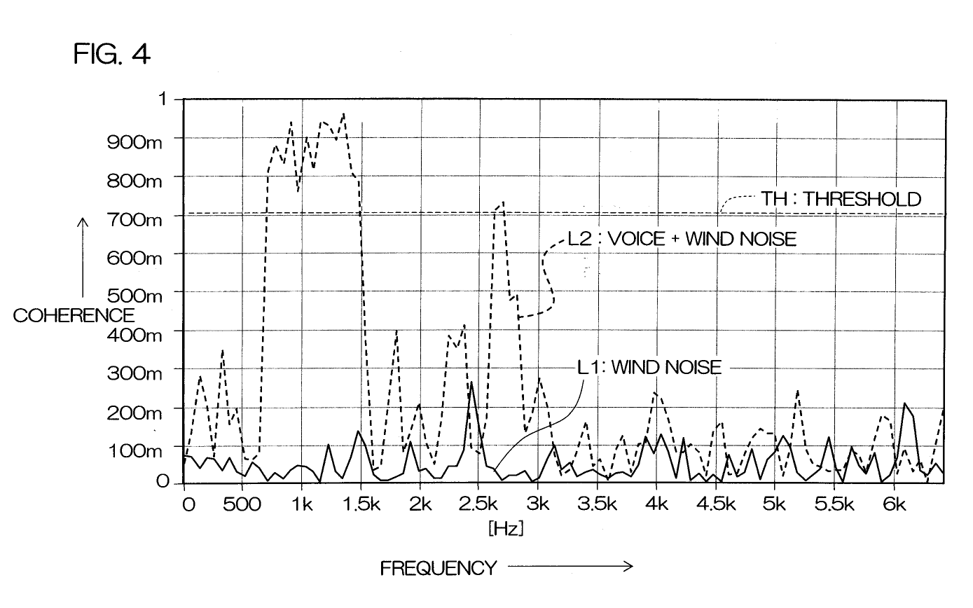

FIG. 4 is an exemplary graph of the coherence computed by the coherence computing section 21. In the graph of FIG. 4, the abscissa and the ordinate denote the frequency of the sound signal and the value of the coherence, respectively. In the graph, “m” represents “milli ( 1/1000)”. A curved line L1 indicates coherence computed when the utterance of the user P is not present and major noise detected by the microphone 102 is wind noise alone. A curved line L2 indicates coherence computed when the utterance of the user P is present.

As can be understood from FIG. 4, the coherence has a high value in the frequency range (e.g., about 700 Hz to about 1.5 kHz) of the voice of the user P in the utterance present period and, hence, exceeds the threshold TH. In contrast, the wind noise is a random noise, so that there is a low correlation between noises respectively detected by the utterance detection microphones 1, 2. Therefore, the coherence has a low value at any frequency.

Therefore, the coherence comparing section 23 (see FIG. 3) compares the coherence of the output signals of the utterance detection microphones 1, 2 with the predetermined threshold TH. If the coherence is higher than the threshold TH in the predetermined frequency range, the utterance judging section 24 (see FIG. 3) judges that the user P is making a noise or utterance. If the coherence is not higher than the threshold TH, the utterance judging section 24 judges that the user P is not making any noise or utterance.

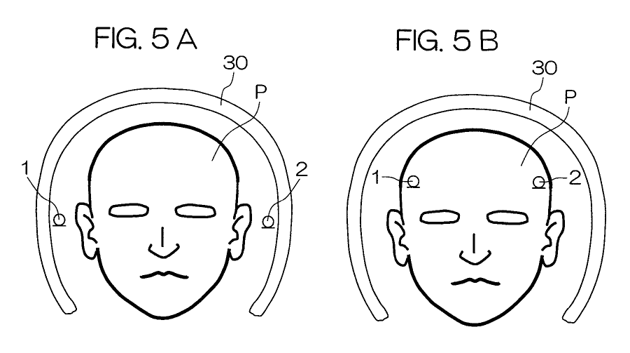

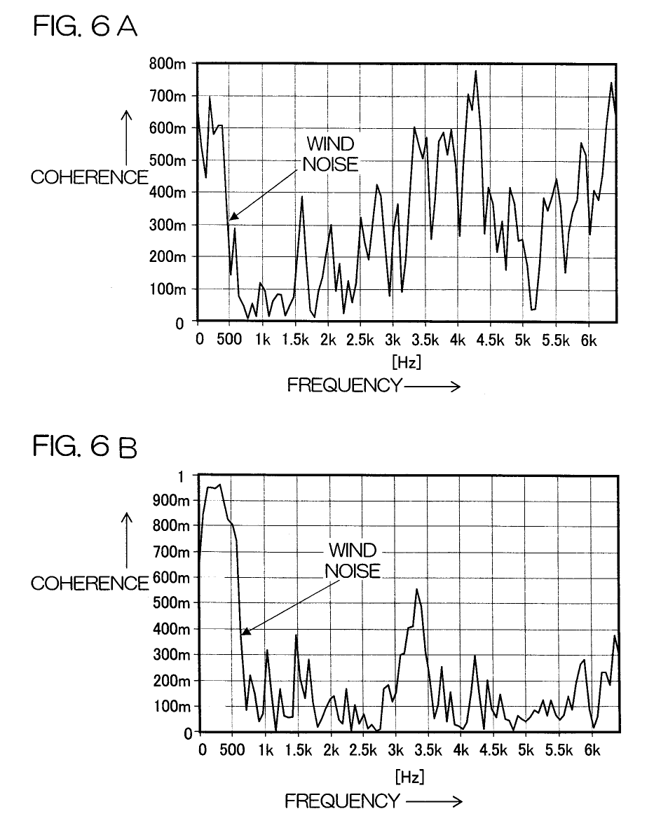

FIGS. 5A and 5B are diagrams for explaining possibly desirable positions of the utterance detection microphones 1, 2 in the helmet body by way of other examples. Where the utterance detection microphones 1, 2 are respectively located in the vicinity of the right and left ears of the user P as shown in FIG. 5A, the coherence of the output signals of the utterance detection microphones 1, 2 in the utterance absent period (in which only the wind noise is present) is as shown in an exemplary graph of FIG. 6A. On the other hand, where the utterance detection microphones 1, 2 are located in the vicinity of the temples (head) of the user P as shown in FIG. 5B, the coherence in the utterance absent period (in which only the wind noise is present) is as shown in an exemplary graph of FIG. 6B.

In either case, the coherence has a great peak at a certain frequency even in the utterance absent period. Therefore, the utterance detection microphones 1, 2 are preferably located in the vicinity of the mouth of the user P as shown in FIG. 1A.

In other words, the positions of the utterance detection microphones 1, 2 are preferably determined so that the coherence has a peak greater than the predetermined threshold in the predetermined frequency range in the utterance present period (during which both the user's voice and the wind noise are present) and such a peak is not present in the utterance absent period (during which only the wind noise is present).

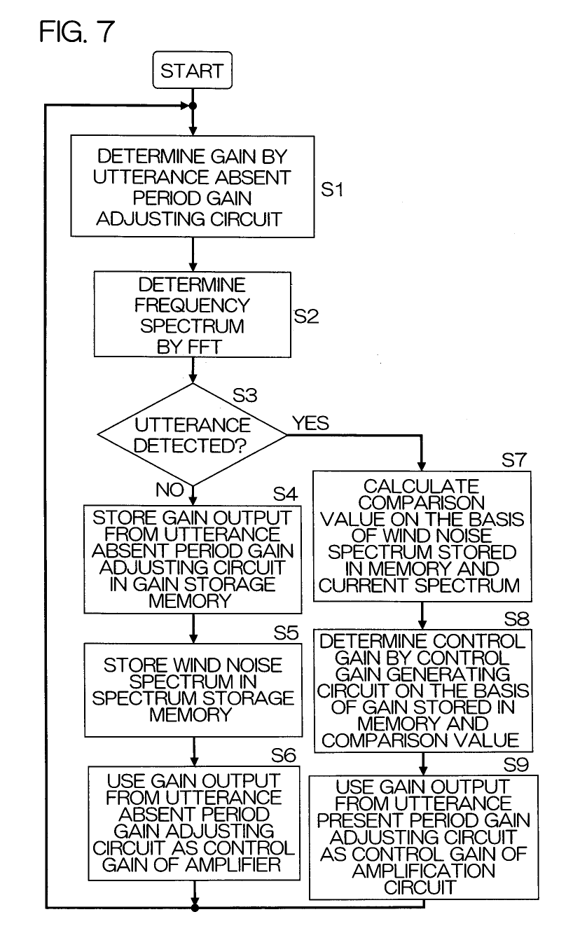

FIG. 7 is a flow chart for explaining the overall operation of the gain adjusting circuit 120. The utterance absent period gain adjusting circuit 121 computes a control gain on the basis of an output signal of the microphone 102 through a process suitable for the utterance absent period (Step S1). On the other hand, the Fast Fourier Transform circuit 8 computes a frequency spectrum for the output signal of the microphone 102 (Step S2).

The utterance detector 3 judges whether or not the user P is making a noise or utterance on the basis of output signals of the utterance detection microphones 1, 2 (Step S3).

In the utterance absent period during which the utterance of the user P is not detected, the control gain generated by the utterance absent period gain adjusting circuit 121 is stored in the gain storage memory 5 (Step S4), and the frequency spectrum (spectrum of the wind noise alone) computed by the Fast Fourier Transform circuit 8 is stored in the spectrum storage memory 9 (Step S5). Then, the control gain generated by the utterance absent period gain adjusting circuit 121 is applied to the amplifier 108 (Step S6).

On the other hand, if the utterance of the user P is detected by the utterance detector 3 (YES in Step S3), the spectrum comparing circuit 12 compares the frequency spectrum computed by the Fast Fourier Transform circuit 8 with the frequency spectrum (the spectrum of the wind noise) stored in the spectrum storage memory 9, and computes a comparison value for the comparison result (Step S7). The comparison value may be, for example, an amplitude ratio or a power ratio at a predetermined frequency (or frequencies).

The control gain generating circuit 13 computes a control gain on the basis of the control gain stored in the gain storage memory 5 and the comparison value (Step S8). The control gain generating circuit 13 may determine the control gain on the basis of a predetermined gain map, or may determine the control gain for the utterance absent period by correcting the control gain stored in the gain storage memory 5 on the basis of the comparison value computed by the spectrum comparing circuit 12.

The control gain thus determined for the utterance absent period is applied to the amplifier 108 (Step S9).

This process is preferably repeatedly performed in a predetermined cycle.

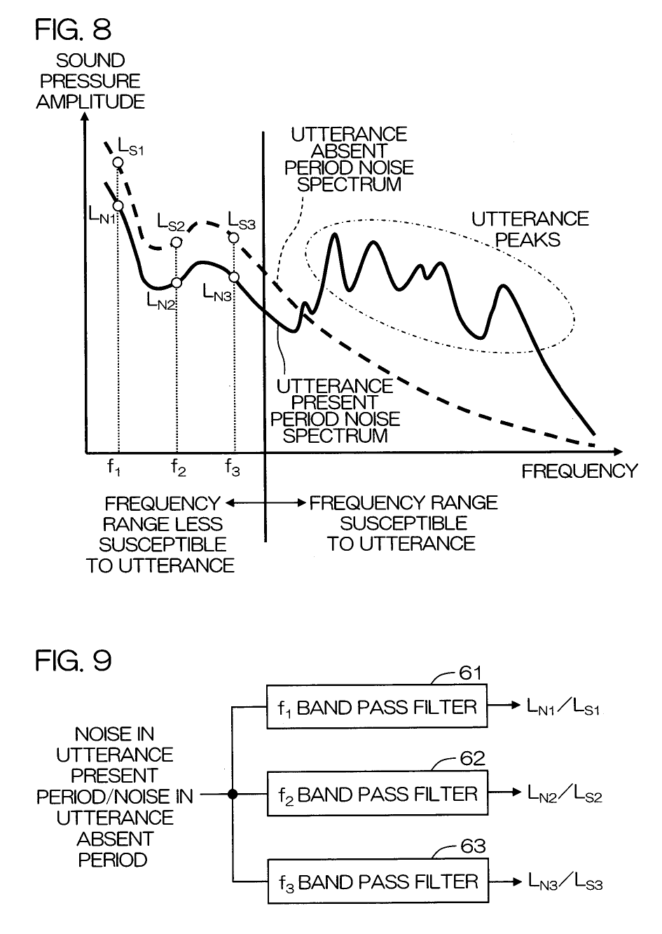

FIG. 8 is a graph obtained by superposing a noise amplitude spectrum observed in the utterance present period on a noise amplitude spectrum observed in the utterance absent period for explaining an exemplary function of the spectrum comparing circuit 12 more specifically. In the noise amplitude spectrum observed in the utterance present period, a wind noise component overlaps with utterance peaks. In this example, the wind noise component is smaller in amplitude in the utterance present period than in the utterance absent period.

A predetermined number of frequencies f₁, f₂, f₃ in a frequency range that is less susceptible to the utterance (or free from the utterance peaks) are preliminarily selected. Noise amplitude spectra observed at the respective frequencies f₁, f₂, f₃ in the utterance present period are herein defined as L_{N1}, L_{N2}, L_{N3}, and noise amplitude spectra at the respective frequencies f₁, f₂, f₃ in the utterance absent period are herein defined as L_{S1}, L_{S2}, L_{S3}.

In this case, the spectrum comparing circuit 12 determines comparison values C₁, C₂, C₃, for example, by calculating the ratios of the amplitude spectra at the respective frequencies as follows:
C₁=L_{N1}/L_{S1}
C₂=L_{N2}/L_{S2}
C₃=L_{N3}/L_{S3}

FIG. 9 is a block diagram illustrating an exemplary construction of the spectrum comparing circuit 12 which preferably includes band pass filters. In this example, the spectrum comparing circuit 12 preferably includes a plurality of band pass filters (e.g., three band pass filters 61, 62, 63) respectively having pass bands centering on the aforementioned frequencies f₁, f₂, f₃ and each having a predetermined width. These band pass filters 61, 62, 63 extract waveform segments of frequency components from the noise waveforms observed in the utterance present period and in the utterance absent period, and outputs the waveform segments.

For the respective waveform segments, absolute value averages, RMSs (root mean squares) or other types of averages are calculated to provide amplitude spectrum equivalent values L_{N1}, L_{S1}, L_{N2}, L_{S2}, L_{N3}, L_{S3}. On the basis of these values, the ratios of the amplitude spectrum equivalent values for the respective frequencies are calculated to provide the comparison values C₁=L_{N1}/L_{S1}, C₂=L_{N2}/L_{S2}, C₃=L_{N3}/L_{S3}.

Since the frequencies f₁, f₂, f₃ fall within the frequency range that is less susceptible to the utterance, the comparison values C₁, C₂, C₃ for the frequencies f₁, f₂, f₃ are associated with a change in the wind noise component alone. Further, the comparison values C₁, C₂, C₃ are defined as the ratios of the wind noise amplitudes observed in the utterance present period to the wind noise amplitudes observed in the utterance absent period, serving as proper indexes for the change in the wind noise component.

It is also possible to use a single comparison value, but a plurality of comparison values are preferably used for accurately detecting the change in the wind noise.

Next, an exemplary process to be performed by the control gain generating circuit 13 for determining the control gain will be described. For example, the control gain generating circuit 13 calculates the control gain K from the following expressions:
(a) K=K_{old}W₁C₁ (where the control gain K is calculated on the basis of a single frequency)
(b) K=K_{old} (W₁C₁+W₂C₂+W₃C₃)(where the control gain K is calculated on the basis of a plurality of frequencies)
   Wherein K_{old} is the control gain stored in the gain storage memory 5, and W₁, W₂, W₃ are weighting factors for the respective frequencies f₁, f₂, f₃. That is, the stored control gain K_{old} is corrected by multiplying the comparison values by the weighting factors to provide the control gain K for the utterance present period.

In a certain vehicle speed range, the proportion of a low frequency noise component in the wind noise increases as the level of the entire wind noise is increased. The proportion of the low frequency noise component in the wind noise decreases as the level of the entire wind noise is reduced. Therefore, it is more effective to increase the control gain K when the proportion of the low frequency noise component is higher and to reduce the control gain K when the proportion of the low frequency noise component is lower, as described later. The control gain K is reasonably calculated from the expression (a) or (b) to satisfy these conditions.

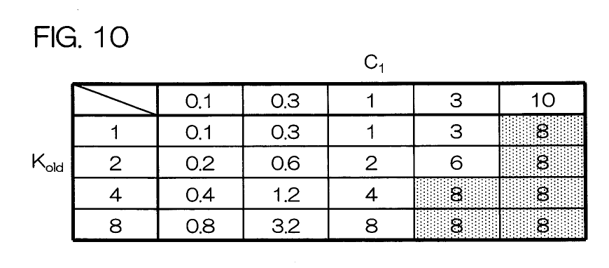

A gain map as shown in FIG. 10, for example, may be used for the computation of the control gain K. The gain map is designed so that a comparison value C₁ is determined on the basis of the amplitude spectrum at the single frequency f₁ (or an amplitude spectrum equivalent value such as an absolute value average of outputs of a band pass filter) and the control gain K is determined on the basis of the comparison value C₁.

Most of the control gain values K in the respective cells of the gain map are substantially equal to values calculated from the expression (a) (where W₁=1.0) and, therefore, reasonable as described above. However, the control gain values K in the shaded cells of the gain map are each set at 8. If the control gain K is excessively increased, howling is liable to occur. Therefore, a ceiling (a predetermined upper limit) is placed on the control gain K in the shaded cells to prevent the occurrence of howling.

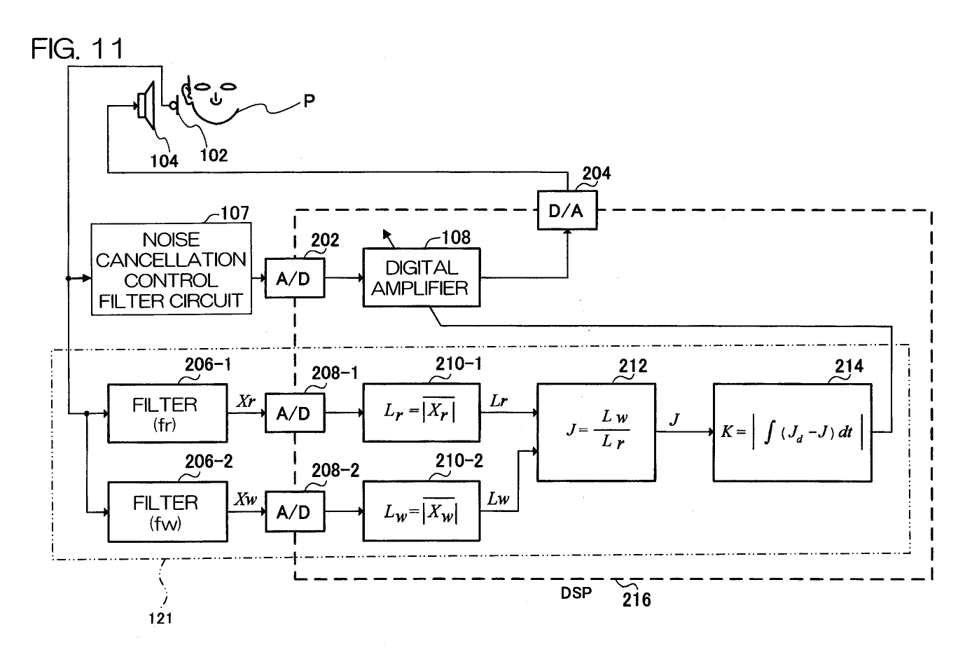

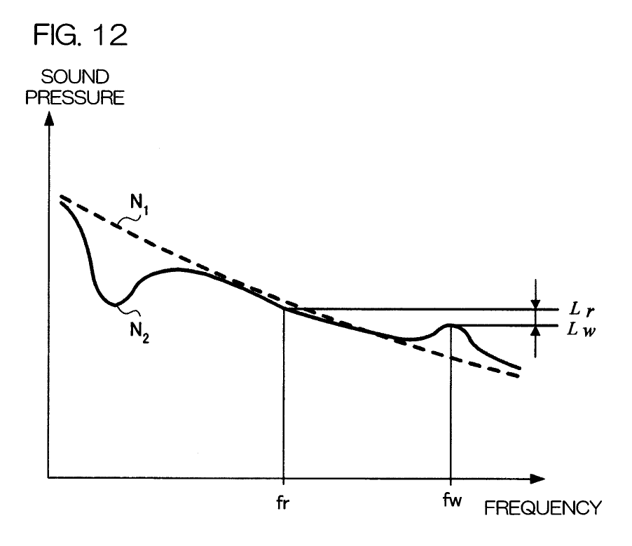

FIG. 11 is a block diagram for explaining an exemplary construction of the utterance absent period gain adjusting circuit 121. FIG. 12 is a diagram for explaining the active noise cancellation control to be performed by the circuit of FIG. 11. FIG. 11 illustrates a preferred circuit construction for the utterance absent period. In this preferred construction, the amplifier 108 is preferably a digital amplifier. The control signal generated by the noise cancellation control filter circuit 107 is input to the digital amplifier 108 via an A/D converter 202. The digital amplifier 108 amplifies the control signal generated by the noise cancellation control filter circuit 107 with the control gain K, and then outputs the amplified control signal to the speaker 104 via a D/A converter 204. The speaker 104 outputs a noise cancellation sound in the ear space on the basis of the input of the amplified control signal so as to cancel the noise.

The utterance absent period gain adjusting circuit 121 includes filters 206-1, 206-2, sound pressure calculating sections 210-1, 210-2 (sound pressure calculating unit), a sound pressure ratio calculating section 212 (sound pressure ratio calculating unit), and an adjustment section 214 (gain controlling unit).

The output signal of the microphone 102 (a sound pressure level at the position of the microphone) is also input to the filters 206-1, 206-2. The filter 206-1 selectively passes signals in a specific frequency range (for example, having a center frequency fr), while the filter 206-2 selectively passes signals in another specific frequency range (for example, having a center frequency fw). The frequency range having the center frequency fr is less susceptible to the active noise cancellation (ANC), and the center frequency fw is a resonance frequency (see FIG. 12). In FIG. 12, a reference character N₁ indicates a spectrum of noise observed in the helmet in an ANC-OFF period, and a reference character N₂ indicates a spectrum of noise observed in the helmet in an ANC-ON period.

The signals Xr, Xw passed through the filters 206-1, 206-2 are respectively input into the sound pressure calculating sections 210-1, 210-2 via A/D converters 208-1, 208-2. The sound pressure calculating section 210-1 calculates an average (sound pressure) Lr of amplitudes of the signals Xr passed through the filter 206-1, and the sound pressure calculating section 210-2 calculates an average (sound pressure) Lw of amplitudes of the signals Xw passed through the filter 206-2 (see FIG. 12). The filter 206-2 and the sound pressure calculating section 210-2 thus function as a first acquisition unit which acquires a sound pressure in the resonance frequency range, while the filter 206-1 and the sound pressure calculating section 210-1 function as a second acquisition unit which acquires a reference sound pressure for comparison. The averages of the amplitudes of the signals passed through the respective filters may each be calculated, for example, as an effective value (RMS) or an average of absolute values of the signals.

The sound pressures Lr, Lw respectively calculated by the sound pressure calculating sections 210-1, 210-2 are input to the sound pressure ratio calculating section 212. The sound pressure ratio calculating section 212 calculates a ratio J (=Lw/Lr) of the input sound pressures Lr, Lw.

The sound pressure ratio J calculated by the sound pressure ratio calculating section 212 is input to the adjustment section 214. The adjustment section 214 adjusts the control gain K (the gain of the digital amplifier 108) on the basis of the input sound pressure ratio J through integration control (I control).

More specifically, a target value J_{d} (target sound pressure ratio) of the sound pressure ratio J is preliminarily determined. Then, a deviation (J_{d}−J) of the sound pressure ratio J from the target value J_{d} is integrated with respect to time, and the absolute value of the integrated deviation is defined as the control gain K as shown in the following expression (1).
K=|∫(J_{d}−J)dt| (1)

That is, the sound pressures Lr, Lw in the specific frequency ranges fr, fw are determined through the filtering and the sound pressure calculation, and the control gain K is adjusted on the basis of the ratio J (=Lw/Lr) of the sound pressures Lr, Lw, in the active noise cancellation control performed by this digital circuit.

In the circuit shown in FIG. 11, the digital amplifier 108, the sound pressure calculating sections 210-1, 210-2, the sound pressure ratio calculating section 212 and the adjustment section 214 are preferably constituted, for example, by a digital signal processor (DSP) 216.

The frequency ranges for the sound pressures to be used for the calculation of the sound pressure ratio J (control index) are not limited to the frequency ranges fr, fw. For example, the control gain K may be adjusted by using the following expressions (2) to (5).

$$\begin{matrix}{L}_{1} ≡ \frac{1}{T} {\int }_{0}^{T} \vert {F}_{1} y ( t ) \vert ⅆ t & ( 2 ) \\ {L}_{2} ≡ \frac{1}{T} {\int }_{0}^{T} \vert y ( t ) \vert ⅆ t & ( 3 ) \\ J ≡ {L}_{1} / {L}_{2} & ( 4 ) \\ K = \vert \int {k}_{p} ( {J}_{d} - J ) ⅆ t \vert & ( 5 )\end{matrix}$$

wherein L₁ is an average of absolute values of the signals obtained by filtering the output signals y of the microphone 102 by a high-pass filter (having a center frequency fw) and corresponds to a sound pressure level in the resonance frequency range, and L_{2 is an average of absolute values of the signals y obtained by passing the output signals y of the microphone 102 as they are and corresponds to a sound pressure level in a full frequency range as the reference frequency range. The ratio J (=L}₁/L₂) of these absolute value averages indicates a proportion of a high frequency component (including a resonance frequency component) in the entire wind noise. Further, J_{d} is an optimum value (target value) of the sound pressure ratio J, and kₚ is a proper constant. Further, F₁ in the expression (2) indicates an operator corresponding to the high-pass filter mentioned above. That is, “F₁y(t)” is an expression of the result obtained by filtering the signal y(t) with the high-pass filter.

The expressions (1) , (5) for determining the control gain each have the following two functions. A first function is to adjust the control gain K so that the sound pressure ratio J is approximated to the target value J_{d}. A second function is to allow the control gain K to have a value that is not less than zero (0). The first function is provided by the integration control (I control), while the second function is provided by the absolute value calculation in the expressions (1), (5). The integration control eliminates a steady-state deviation of the sound pressure ratio J from the target value J_{d} which can be eliminated by neither proportional control (P control) nor differential control (D control). Therefore, the control method preferably includes at least the integration control, but may also include the proportional control and/or the differential control in combination with the integration control.

The absolute value calculation prevents a malfunction (divergence) which may otherwise occur when the control gain K adjusted by the digital circuit has a negative value.

More specifically, it is known that the sound pressure ratio J is steadily increased with the control gain K, so that the control gain K is calculated by integrating the deviation (J_{d}−J) with respect to time. If the sound pressure ratio J is smaller than the target value J_{d}, the gain K is gradually increased and, at the same time, the sound pressure ratio J is increased. Conversely, if the sound pressure ratio J is greater than the target value J_{d}, the gain K is gradually reduced and, at the same time, the sound pressure ratio J is reduced. Thus, the sound pressure ratio J converges on the target value J_{d}, whereby the spectrum of the output signals of the microphone 102 is optimized.

On the other hand, if the control gain K was reduced to a negative value, the divergence (howling) would occur. In this preferred embodiment, however, the control gain K is calculated as the absolute value of the integrated value for prevention of the divergence. Therefore, the control gain K has a lower limit of 0.

Hence, the control gain K can be adjusted at an optimum level through the integration control based on the expression (1) or (5).

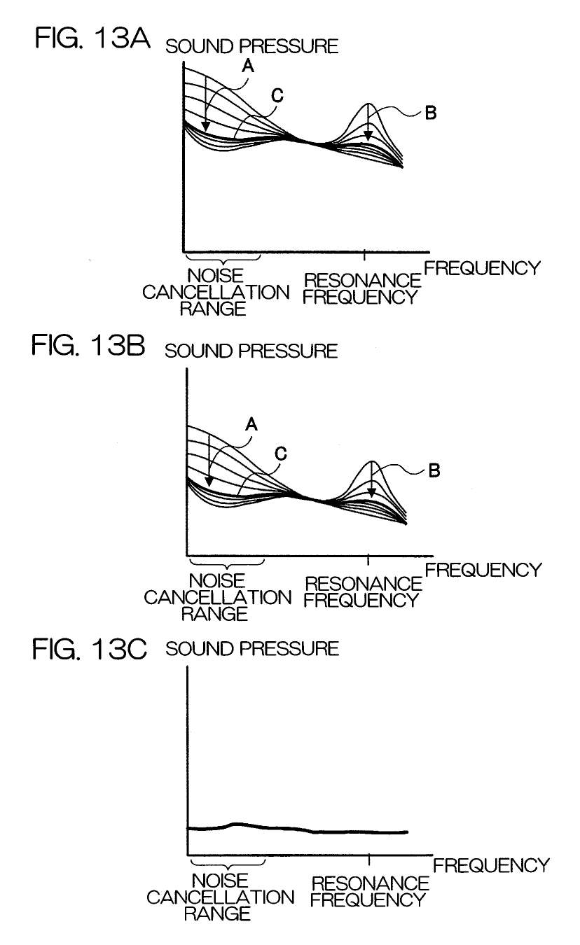

FIGS. 13A, 13B and 13C are diagrams for explaining the effects of the active noise cancellation control to be performed by the utterance absent period gain adjusting circuit 121. Particularly, FIG. 13A illustrates an effect achieved when great wind noise is present, and FIG. 13B illustrates an effect achieved when small wind noise is present. FIG. 13C illustrates an effect achieved when no wind noise is present.

The active noise cancellation control performed by the utterance absent period gain adjusting circuit 121 eliminates the individual differences in the auditory sound conduction function, and is optimized irrespective of the level of the wind noise. That is, one of the aims of the active noise cancellation control is to approximate the profile of the noise (wind noise) spectrum to a target spectrum profile. An exemplary target spectrum profile is such that the sound pressure L₂ is about ten times as great as the sound pressure L₁ (with a sound pressure difference of about +20 dB) , i.e., the target value J_{d} in the expression (5) is set at J_{d}= 1/10. Then, the control gain K is adjusted through the calculation of the expression (5) so that the ratio J (=L₁/L₂) of the current sound pressures L₁, L₂ is equalized with the target value J_{d}. That is, the control is not dependent upon the absolute values of the microphone output signals, because the ratio of the sound pressures in the different frequency ranges is used.

Further, when the sound pressure L₁ in the resonance frequency range is amplified through the active noise cancellation (ANC) , the user P recognizes the level of the amplified sound pressure (loudness) by comparison with the level of the sound pressure L₁ observed before the ANC. In other words, where a sound pressure in a frequency range f₃ that is less susceptible to the ANC is defined as L₃, the user P recognizes the loudness by comparing the level of the sound pressure L₃ observed after the ANC with the level of the sound pressure L₁ observed after the ANC. This is because the level of the sound pressure L₃ is rarely changed by the ANC (though influenced by the whole noise level). Therefore, a proper relationship (noise pressure ratio after the ANC) which ensures moderate cancellation of the noise in the noise cancellation range (in a major wind noise frequency range to be subjected to the ANC) while suppressing the loudness of the noise in the resonance frequency range can be determined between the sound pressures L₃ and L₁. Such a proper relationship is not limited to that determined between the sound pressures L₃ and L₁ in the specific frequency ranges, but can be determined between sound pressures in every possible combination of frequencies. Therefore, in general, an optimum spectrum profile can be determined which ensures hearing comfort after the ANC.

Since the sound pressure L₂ indicating the sound pressure level in the full frequency range is not changed by the ANC, the sound pressure ratio J=L₁/L₂ indicates the spectrum profile dependent upon the control gain K. Therefore, the optimum spectrum profile can be provided by adjusting the control gain K to approximate the sound pressure ratio J to the target value J_{d}.

In FIGS. 13A and 13B, for example, the control gain K is increased if the noise level is high in a low frequency range (noise cancellation range) or the sound pressure ratio J is low. Thus, the noise level in the low frequency range is reduced as indicated by an arrow A in FIGS. 13A and 13B. On the other hand, if the noise level is high in a high frequency range (resonance frequency range) or the sound pressure ratio J is high, the control gain K is reduced. Thus, the noise level in the high frequency range is reduced as indicated by an arrow B in FIGS. 13A and 13B. The control gain K is thus automatically controlled through the integration control based on the expression (1) or (5), whereby the spectrum profile is approximated to the optimum target spectrum profile.

In addition, as shown in FIGS. 13A and 13B, the target spectrum profile is not dependent upon the entire noise level. That is, the profile of the target spectrum is not varied by the level of the wind noise, so that the target value J_{d} realizing the target spectrum can be set at a constant level. Therefore, the optimum control can be performed irrespective of the level of the wind noise by adjusting the control gain K through the integration control using the sound pressure ratio J.

The final goal of the active cancellation of the wind noise is to approximate the wind noise spectrum profile to the appropriate spectrum profile to ensure the hearing comfort, as described above. Although a spectrum profile for every user P can be approximated to the target spectrum profile by adjusting the control gain K, the value of the control gain K for the approximation differs from user to user due to the individual differences in the auditory sound conduction function. For elimination of the individual differences, therefore, the spectrum profile should be directly monitored when the control gain K is adjusted to approximate the spectrum profile to the appropriate spectrum profile. This is also realized by the integration control based on the sound pressure ratio J.

If the wind noise is not present, the control gain K is set at zero (0), and the active noise cancellation is not performed as shown in FIG. 13C. Therefore, there is no possibility that the noise signal is needlessly amplified. That is, background noise (mainly a high frequency noise component) is more dominant in the microphone output signals without the wind noise compared with the case where the wind noise is present. Therefore, the proportion of the high frequency noise component in the entire noise is increased as compared with a case where the wind noise is present. Accordingly, the value of the sound pressure ratio J (=L₁/L₂ or Lw/Lr) exceeds the target value J_{d}, and the control gain K is continuously reduced, for example, according to the expression (5). However, the control gain K never has a negative value because of the absolute value calculation. Therefore, the control gain K finally converges on K=0, so that the output of the speaker 104 is reduced to zero (0). That is, the active noise cancellation is not performed.

Thus, the utterance absent period gain adjusting circuit 121 configured as shown in FIG. 11 performs the noise cancellation by approximating the frequency spectrum profile of the wind noise detected by the microphone 102 to the target spectrum profile. Therefore, if the frequency spectrum of the output signals of the microphone 102 is influenced by the utterance of the user P, there is a possibility that the utterance absent period gain adjusting circuit 121 fails to properly determine the control gain for the noise cancellation.

Therefore, in this preferred embodiment, when the utterance of the user P is detected, the utterance present period gain adjusting circuit 122 instead of the utterance absent period gain adjusting circuit 121 determines the control gain of the amplifier 108. Thus, the noise cancellation can be properly performed in the utterance absent period as well as in the utterance present period.

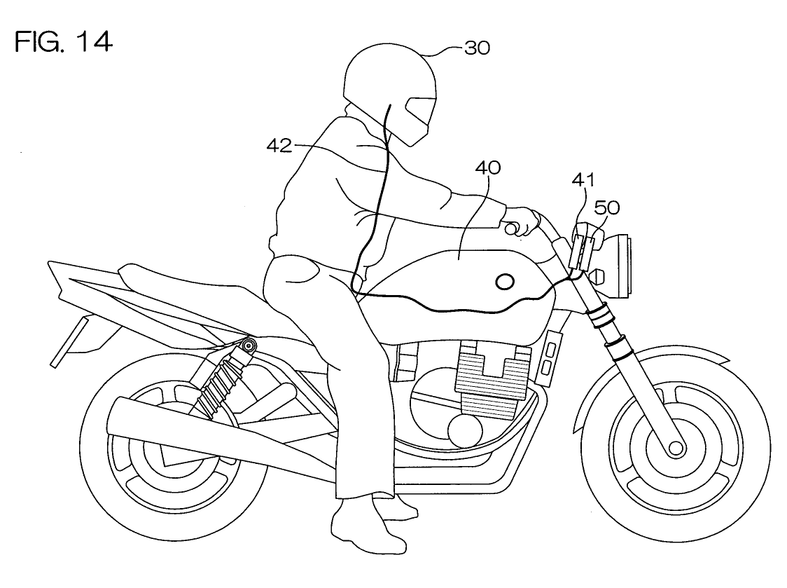

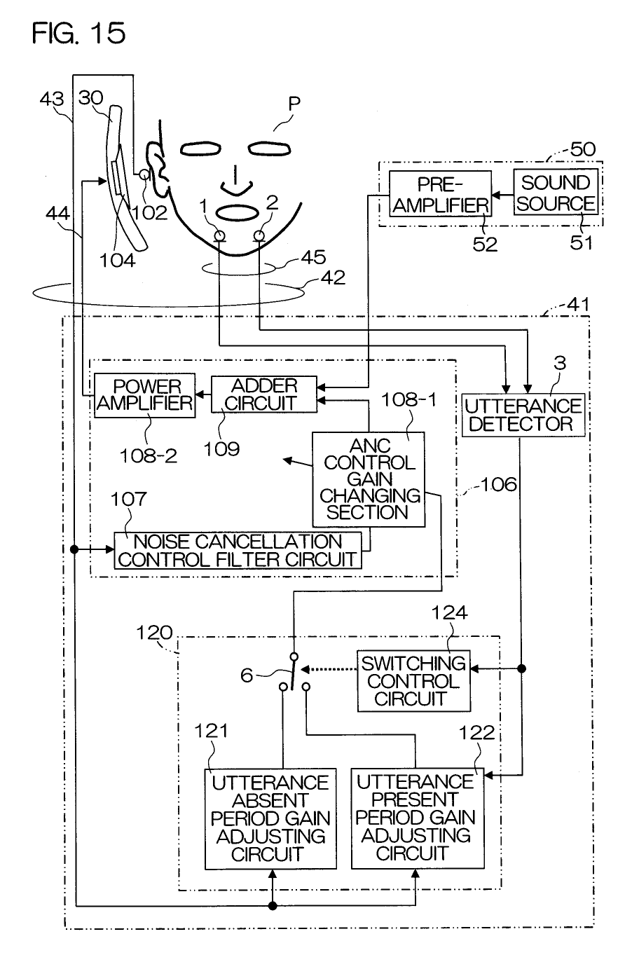

FIG. 14 is a diagram illustrating a preferred overall construction of a motor vehicle system including the active noise cancellation helmet according to another preferred embodiment of the present invention. FIG. 15 is a block diagram illustrating a preferred electrical construction of the motor vehicle system. In FIGS. 14 and 15, elements corresponding to those shown in FIGS. 1A and 1B will be denoted by the same reference characters as in FIGS. 1A and 1B.

In this preferred embodiment, only the microphone 102, the speaker 104 (e.g., a panel speaker) and the utterance detection microphones 1, 2 out of the elements of the active noise cancellation helmet are mounted in the helmet body 30, and the other elements including the control signal generating circuit 106 are preferably provided in an ANC controller amplifier 41 as a vehicle-side device mounted in a vehicle body 40 of a two-wheeled vehicle as an exemplary motor vehicle. The ANC controller amplifier 41 is preferably connected to the microphone 102 and the speaker 104 via a wire harness 42 including a plurality of cables bundled together.

The wire harness 42 is a communication unit which includes a microphone signal line 43 arranged to input the output signals of the microphone 102 into the ANC controller amplifier 41, a sound signal line 44 arranged to apply the noise cancellation control signal to the speaker 104 from the ANC controller amplifier 41, and utterance detection microphone signal lines 45 arranged to input the output signals of the utterance detection microphones 1, 2 into the ANC controller amplifier 41.

An audible information generating device 50 (audible information generating unit) is provided in the vehicle body 40, and connected to the sound signal line 44. The audible information generating device 50 preferably includes a sound source 51 which generates a sound signal, and a preamplifier 52 which amplifies the sound signal generated by the sound source 51 and outputs the amplified sound signal to the control signal generating circuit 106.

In this preferred embodiment, the control signal generating circuit 106 preferably includes an ANC control gain changing section 108-1, an adder circuit 109 and a power amplifier 108-2. The ANC control gain changing section 108-1 is preferably a preamplifier circuit which amplifies the control signal applied from the noise cancellation control filter circuit 107 according to the control gain generated by the gain adjusting circuit 120. The control signal output from the ANC control gain changing section 108-1 is added to the output signal of the preamplifier 52 of the audible information generating device 50 in the adder circuit 109. A signal obtained by the addition is amplified with a predetermined gain by the power amplifier 108-2 and output to the sound signal line 44.

Therefore, the sound signal line 44 also functions as a transmission unit which transmits the sound signal generated by the audible information generating device 50 to the helmet body 30.

Thus, the speaker 104 provided in the helmet body 30 constantly outputs the noise cancellation sound on the basis of the control signal, and outputs a sound on the basis of the sound signal generated by the audible information generating device 50 when necessary. That is, the speaker 104 also functions as an audible information outputting unit which outputs audible information. Thus, the wearer of the helmet body 30 hears the audible information output from the audible information generating device 50 with the wind noise being properly cancelled.

The audible information generating device 50 may be a navigation device which provides an audible guidance message, an audio device such as a radio or an audio player, or a mobile phone (for example, having a mail reading-out function as well as a basic conversation function).

The ANC controller amplifier 41 and the audible information generating device 50 are not necessarily required to be connected to the helmet body 30 via the cables, but the signal transmission may be achieved by wireless communication such as infrared communication or radio communication.

This preferred embodiment is also applicable to a four-wheeled vehicle, as long as a driver of the vehicle is required to wear a helmet.

While the present invention has been described in detail by way of the preferred embodiments thereof, it should be understood that the foregoing disclosure is merely illustrative of the technical principles of the present invention but not limitative of the same. The spirit and scope of the present invention are to be limited only by the appended claims.

This application corresponds to Japanese Patent Application No. 2005-154502 filed in the Japanese Patent Office on May 26, 2005, the disclosure of which is incorporated herein by reference.

What is claimed is:

1. A noise cancellation helmet comprising:
a noise detecting unit that is arranged to detect noise in a helmet body;
a sound outputting unit that is arranged to output a control sound to cancel the noise detected by the noise detecting unit;
a control signal generating unit that is arranged to process an output signal of the noise detecting unit to generate a control signal for the control sound and apply the control signal to the sound outputting unit;
an utterance detecting unit that is arranged to detect an utterance of a wearer who wears the helmet body;
an utterance absent period gain adjusting unit that is arranged to adjust a gain of the control signal generating unit in an utterance absent period during which no utterance is detected by the utterance detecting unit;
an utterance absent period gain storing unit that is arranged to store a gain set by the utterance absent period gain adjusting unit immediately before the utterance is detected by the utterance detecting unit; and
an utterance present period gain adjusting unit that is arranged to adjust the gain of the control signal generating unit on the basis of the gain stored in the utterance absent period gain storing unit in an utterance present period during which the utterance is detected by the utterance detecting unit.

2. A noise cancellation helmet as set forth in claim 1, wherein the utterance present period gain adjusting unit is arranged to adjust the gain of the control signal generating unit in accordance with the output signal of the noise detecting unit and the gain stored in the utterance absent period gain storing unit.

3. A noise cancellation helmet as set forth in claim 1, wherein the utterance present period gain adjusting unit includes:
a spectrum computing unit that is arranged to compute a frequency spectrum of the noise in the helmet body on the basis of the output signal of the noise detecting unit;
an utterance absent period noise spectrum storing unit that is arranged to store a frequency spectrum computed by the spectrum computing unit immediately before the utterance is detected by the utterance detecting unit;
a spectrum comparing unit that is arranged to compare a noise frequency spectrum computed by the spectrum computing unit in the utterance present period during which the utterance is detected by the utterance detecting unit with the frequency spectrum stored in the utterance absent period noise spectrum storing unit; and
a gain controlling unit that is arranged to control the gain of the control signal generating unit on the basis of a result of the comparison by the spectrum comparing unit and the gain stored in the utterance absent period gain storing unit.

4. A noise cancellation helmet as set forth in claim 3, wherein the spectrum comparing unit is arranged to compare an amplitude spectrum of the noise frequency spectrum computed by the spectrum computing unit in the utterance present period during which the utterance is detected by the utterance detecting unit or its equivalent value with an amplitude spectrum of the frequency spectrum stored in the utterance absent period noise spectrum storing unit or its equivalent value at a specific frequency in a frequency range which is substantially free from an utterance peak attributable to the utterance of the wearer.

5. A noise cancellation helmet as set forth in claim 4, wherein the specific frequency includes a plurality of different frequencies.

6. A noise cancellation helmet as set forth in claim 4, wherein the gain controlling unit is arranged to determine the gain of the control signal generating unit by correcting the gain stored in the utterance absent period gain storing unit on the basis of the result of the comparison by the spectrum comparing unit.

7. A noise cancellation helmet as set forth in claim 1, wherein the utterance absent period gain adjusting unit includes:
a sound pressure ratio acquiring unit that is arranged to acquire a ratio of sound pressures in different frequency ranges on the basis of the output signal of the noise detecting unit; and
a gain controlling unit that is arranged to control the gain of the control signal generating unit on the basis of the sound pressure ratio acquired by the sound pressure ratio acquiring unit so as to approximate a spectrum of the output signal of the noise detecting unit to a predetermined target spectrum.

8. A noise cancellation helmet as set forth in claim 1, further comprising first and second voice detecting units that are arranged to detect a voice of the wearer of the helmet body at different positions within the helmet body and output voice signals, wherein
the utterance detecting unit includes:
a correlation computing unit that is arranged to compute a correlation value indicating a correlation between the voice signals respectively output from the first and second voice detecting units; and
an utterance judging unit that is arranged to judge whether or not the wearer is making an utterance on the basis of the correlation value computed by the correlation computing unit.

9. A noise cancellation helmet as set forth in claim 8, wherein the first and second voice detecting units are respectively located at positions that are substantially equidistant from a mouth of the wearer of the helmet body.

10. A noise cancellation helmet as set forth in claim 8, wherein the first and second voice detecting units are respectively located in the helmet body at positions such that the correlation value computed by the correlation computing unit is not lower than a predetermined threshold in the utterance present period during which the utterance of the wearer of the helmet body is present, and lower than the threshold in the utterance absent period during which the utterance of the wearer is absent.

11. A motor vehicle system comprising:
a vehicle body; and
the noise cancellation helmet according to claim 1; wherein
at least the noise detecting unit and the sound outputting unit are mounted in the helmet body of the noise cancellation helmet; and
at least some of the components of the noise cancellation helmet other than the noise detecting unit and the sound outputting unit constitute a vehicle-side device provided in the vehicle body; wherein
the motor vehicle system further includes a communication unit that is arranged to transmit a signal between the vehicle-side device and the noise detecting unit and between the vehicle-side device and the sound outputting unit.

12. A motor vehicle system comprising:
a vehicle body;
the noise cancellation helmet according to claim 1;
an audible information generating unit provided in the vehicle body and arranged to generate audible information;
a transmission unit that is arranged to transmit the audible information generated by the audible information generating unit to the helmet body of the noise cancellation helmet; and
an audible information outputting unit provided in the helmet body and arranged to output the audible information transmitted by the transmission unit.

13. A noise cancellation helmet comprising:
a noise detecting unit that is arranged to detect noise in a helmet body;
a sound outputting unit that is arranged to output a control sound to cancel the noise detected by the noise detecting unit;
a control signal generating unit that is arranged to process an output signal of the noise detecting unit to generate a control signal for the control sound and apply the control signal to the sound outputting unit;
first and second voice detecting units that are arranged to detect voice of a wearer of the helmet body at different positions within the helmet body and output voice signals;
an utterance detecting unit including a correlation computing unit that is arranged to compute a correlation value indicating a correlation between the voice signals respectively output from the first and second voice detecting units, and an utterance judging unit that is arranged to judge whether or not the wearer of the helmet body is making an utterance on the basis of the correlation value computed by the correlation computing unit;
an utterance absent period gain adjusting unit that is arranged to adjust a gain of the control signal generating unit in an utterance absent period during which no utterance is detected by the utterance detecting unit; and
an utterance present period gain adjusting unit that is arranged to adjust the gain of the control signal generating unit through a process different from that performed by the utterance absent period gain adjusting unit in an utterance present period during which the utterance is detected by the utterance detecting unit.

14. A motor vehicle system comprising:
a vehicle body; and
the noise cancellation helmet according to claim 13; wherein
at least the noise detecting unit and the sound outputting unit are mounted in the helmet body of the noise cancellation helmet; and
at least some of the components of the noise cancellation helmet other than the noise detecting unit and the sound outputting unit constitute a vehicle-side device provided in the vehicle body; wherein
the motor vehicle system further includes a communication unit that is arranged to transmit a signal between the vehicle-side device and the noise detecting unit and between the vehicle-side device and the sound outputting unit.

15. A motor vehicle system comprising:
a vehicle body;
the noise cancellation helmet according to claim 13;
an audible information generating unit provided in the vehicle body and arranged to generate audible information;
a transmission unit that is arranged to transmit the audible information generated by the audible information generating unit to the helmet body of the noise cancellation helmet; and
an audible information outputting unit provided in the helmet body and arranged to output the audible information transmitted by the transmission unit.

16. A method of canceling noise in a helmet comprising the steps of:
detecting noise in a helmet body by a noise detecting unit;
outputting a control sound from a sound outputting unit to cancel the detected noise;
processing an output signal of the noise detecting unit to generate a control signal, amplifying the generated control signal by an amplification unit and applying the amplified control signal to the sound outputting unit;
detecting an utterance of a wearer who wears the helmet body;
adjusting a gain of the amplification unit in an utterance absent period during which the utterance of the wearer is not detected; and
adjusting the gain of the amplification unit on the basis of a gain set in the immediately preceding utterance absent period gain adjusting step in an utterance present period during which the utterance of the wearer is detected.

17. A method of canceling noise in a helmet comprising the steps of:
detecting noise in a helmet body by a noise detecting unit;
outputting a control sound from a sound outputting unit to cancel the detected noise;
processing an output signal of the noise detecting unit to generate a control signal, amplifying the generated control signal by an amplification unit and applying the amplified control signal to the sound outputting unit;
detecting voice of a wearer of the helmet body at different positions within the helmet body by first and second voice detecting units;
computing a correlation value indicating a correlation between voice signals respectively output from the first and second voice detecting units;
judging whether or not the wearer of the helmet body is making an utterance on the basis of the calculated correlation value;
adjusting a gain of the amplification unit in an utterance absent period during which it is judged that the wearer is not making an utterance; and
adjusting the gain of the amplification unit through a process different from that performed in the utterance absent period gain adjusting step in an utterance present period during which it is judged that the wearer is making an utterance.
